(19) United States
(12) Patent Application Publication
(10) Pub. No.: US 2023/0305622 A1
(43) Pub. Date: Sep. 28, 2023

(54) METHODS AND SYSTEMS FOR HYBRID VIRTUAL REALITY TRAVEL USER INTERFACE

(71) Applicants: David John CLEMENT, Vancouver (CA); SIMON FRASER UNIVERSITY, Bumaby (CA)

(72) Inventors: Ernst Bernhard RIECKE, Vancouver (CA); Markus VON DER HEYDE, Weimar (DE); David John Clement, Vancouver (CA)

(21) Appl. No.: 18/126,155

(22) Filed: Mar. 24, 2023

Related U.S. Application Data
(60) Provisional application No. 63/323,991, filed on Mar. 25, 2022.

(51) Int. Cl. G06F 3/01; G06T 19/00

(52) U.S. Cl. CPC G06F 3/011; G06T 19/003

(57) ABSTRACT

The disclosure herein provides for adjusting motion parameter parameters and thresholds for VR locomotion. The system receives a first input from a VR interface. The first input comprises a first motion parameter. The system then determines whether the first motion parameter exceeds a motion parameter threshold. If the first motion parameter exceeds the motion parameter threshold, then the system determines an adjusted motion parameter. The system then configures the adjusted motion parameter to be applied to the first motion parameter.

### BACKGROUND

The present disclosure is directed to systems and methods for providing a locomotion paradigm which may be used in virtual reality (“VR”) applications.

### SUMMARY

Teleportation is a common metaphor of VR locomotion. In this metaphor, the user is discretely moved to a target destination as opposed to continuous travel methods where the users continuously control or steer their travel direction along the way. Some conventional technical travel techniques for VR include target destination can be chosen in multiple ways, including a common method of pointing with a controller. Teleportation generally does not induce cybersickness, especially compared to controller-based continuous locomotion methods. Therefore, teleportation is commonly used as a target-based travel technique. However, while comparing different travel techniques and metaphors for VR, it was determined that teleportation techniques due to their abrupt view changes can be disorienting compared to continuous travel techniques.

In particular, spatial updating is a mental process of maintaining (“updating”) the spatial relationship between ourselves and our surroundings during self-motion, where self-to-object relationships constantly change. It is important for effective navigation, spatial orientation, and situational awareness. This process is largely automated or even obligatory (i.e., hard to suppress) during natural walking and also takes place during more complex activities like driving, climbing, diving, flying, or playing sports. However, only imagining the self-motions does not generate the same level of spatial updating and does not seem to be able to elicit automatic or obligatory spatial updating.

The discrete jumps in teleportation also remove any self-motion cues that could be used to path-integrate and thus support automatic spatial updating. That is, for teleportation, one has to rely on other means to recover orientation, such as landmark-based piloting, which makes it less effective than using a combination of path integration and piloting. Conversely, dynamic translation information (either visual or body-based self-motion cues) provided by continuous travel methods has been shown to help users perform better in spatial updating tasks.

On the downside, any continuous locomotion model provides continuous optical flow, which limits the maximum acceleration and speed that can be applied without causing cybersickness. As a result, large-scale continuous navigation without teleportation might simply take too long or become annoying/boring for the user to be an effective locomotion mode from a pragmatic perspective. Said another way, conventional continuous travel techniques for VR are deficient in providing efficient travel due to constraining factors of acceleration and speed as to not induce cybersickness.

Accordingly, the disclosure herein provides for a hybrid VR travel technique to provide efficient travel by merging concepts from continuous and discontinuous (e.g., teleportation) travel into one seamless locomotion paradigm. The present disclosure provides for a hybrid VR travel user interface that uses continuous movement for short distances or low locomotion speeds/accelerations (just like a regular controller-based or leaning-based interface), and beyond that utilizes a more rapid mode of locomotion. For example, during more rapid movement, techniques may provide for implementation of at least one or more of the following iterative teleportation/jumps at regular/irregular intervals, cross-fading to new locations, dashing, very fast dashing (“micro-dashing”). In these techniques the teleportation does not create any optical flow during the jumps (or only minimal optical flow when dashing), thus reducing the risk of cybersickness. For example, micro-dashing provides not enough visual cues to induce apparent self-motion, and thus similarly reduces motion sickness. For example, FIG. 2 illustrates a standing user using a leaning-based VR locomotion interface (Similar to NaviBoard, see Nguyen-Vo et al., 2019) where a VR headset provides an input of distance and direction from the zero point which can be used to control translational speed in VR, similar to deflecting a joystick.

The disclosure herein provides for adjusting motion parameters and thresholds for VR locomotion. The system receives a first input from a VR interface. The first input comprises a first motion parameter. The system then determines whether the first motion parameter exceeds a motion parameter threshold. If the first motion parameter exceeds the motion parameter threshold, then the system determines an adjusted motion parameter. The system then configures the adjusted motion parameter to be applied to the first motion parameter.

In some embodiments, the system may receive a second input from the VR interface, wherein the second input comprises a second motion parameter. The system then determines whether a difference between the first motion parameter and the second parameter exceeds a motion parameter threshold. If this threshold is exceeded, the system determines an adjusted motion parameter threshold and configures the adjusted motion parameter to be applied to the second motion parameter.

In yet other embodiments, the system may determine a target location. The system then determines an adjusted motion parameter based on the target location and the configures the adjusted motion parameter to be applied to the first motion parameter.

In some embodiments, the system may determine the motion parameter threshold for a first application. The system may then store the motion parameter threshold for a first application in a database. The system may then retrieve the motion parameter threshold for a first application in a database to apply to a motion parameter threshold for a second application.

In one embodiment, the VR travel user interface switches between one or more modes of locomotion without having an express user input to select or toggle between the one or more modes.

Furthermore, the jumping distance may be chosen to be independent of optical flow. Thus, the jumping distance may be configured to adjust to any desired length and direction/orientation without effectively changing the risk of cybersickness. In the scenario where the teleportation distance exceeds a specific distance threshold, the specific distance threshold may be determined based on user preferences or the likelihood of adverse effects (such as disorientation or cybersickness) for particular user(s). In one embodiment, the technique interlaces continuous movements with relative short repeated jumps to provide sufficient optical flow and predictability of one’s post-jump location to help maintain users’ spatial updating capabilities while effectively limiting the optical flow so that it does not exacerbate cybersickness during fast/long-distance travel.

### BRIEF DESCRIPTION OF THE DRAWINGS

The below and other objects and advantages of the disclosure will be apparent upon consideration of the following detailed description, taken in conjunction with the accompanying drawings, in which the reference characters refer to like parts throughout, and in which:

FIG. 1 illustrates a HyperJump threshold is reached, the continuous locomotion is augmented by adding iterative “HyperJumps,” in accordance with some embodiments of the disclosure;

FIG. 2 illustrates a standing user using a leaning-based VR locomotion interface, in accordance with some embodiments of the disclosure;

FIG. 3 illustrates various types of errors associated with the participant in the VR environment, in accordance with some embodiments of the disclosure;

FIG. 4 illustrates various paths a participant has taken in a VR environment, in accordance with some embodiments of the disclosure;

FIG. 5 shows a system diagram of a travel VR UI engine, VR UI database, a network, and user hardware, in accordance with some embodiments of the disclosure;

FIG. 6 shows a block diagram of a VR UI engine, in accordance with some embodiments of the disclosure;

FIG. 7 is an illustrative flowchart of a process for configuring the adjusted motion parameter to be applied to the first motion parameter, in accordance with some embodiments of the disclosure;

FIG. 8 is an illustrative flowchart of a process for configuring the adjusted motion parameter to be applied to the second motion parameter, in accordance with some embodiments of the disclosure; and

FIG. 9 is an illustrative flowchart of a process for retrieving the motion parameter threshold for a first application in a database to apply to a motion parameter threshold for a second application, in accordance with some embodiments of the disclosure.

### DETAILED DESCRIPTION

The disclosure herein provides for adjusting motion parameters and thresholds for VR locomotion. A system may be configured to adjust these motion parameters in VR by implementing a Travel VR User Interface (“UI”) Engine. For example, the Travel VR User Interface Engine may include a computer configured to run specific hardware, software, firmware or any combination thereof to adjust these motion parameters in VR. The Travel VR User Interface Engine receives a first input from a VR interface. For example, the Travel VR User Interface Engine may receive an input from a VR headset. The VR headset is configured with accelerometers and various other sensors or tracking systems to determine a motion parameter. The first input includes a motion parameter. A motion parameter may be one of velocity, acceleration, changes in acceleration, distance, coordinates, and/or any combination thereof. In some embodiments, the motion parameter may refer to a plurality of parameters (e.g., velocity components for horizontal, vertical, etc.). The motion parameter may be any metric related to motion of a user in VR. The Travel VR User Interface Engine may then determine whether the first motion parameter exceeds a motion parameter threshold. For example, the Travel VR User Interface Engine may determine an acceleration value for the first motion parameter. The Travel VR User Interface Engine may be calibrated to have a motion parameter threshold customized for the VR user. Calibration may be performed by various techniques which include determining the threshold of cybersickness via motion simulations and/or user data entry (e.g., questionnaire). In another variant, the Travel VR User Interface Engine may perform calibration based on the inputs from the first input. The Travel VR User Interface Engine may be calibrated to determine the motion parameter threshold for a first application and store the motion parameter threshold for a first application in a database. The Travel VR User Interface Engine may then retrieve the motion parameter threshold for a first application in a database to apply to a motion parameter threshold for a second application. The application may be a specific device application. The application may also be different sessions of a single device application. In some embodiments, the motion parameter threshold is configured by an administrator. In some embodiments, the data for calibration may be retrieved from a VR UI database. The VR UI database may include data relating to participant behavioural data including, but not limited to, body sway, centre of mass changes, postural changes, gestures, mimicry, verbal or non-verbal communication, and indicate relevant aspects such was distress/unease/motion sickness, disorientation. In some embodiments, this data may be generated by behavioural, neurophyiological, physiological, neurochemical markers either by threshold on individual markers/measures or combinations thereof.

In some embodiments, the Travel VR User Interface Engine then determines If the first motion parameter exceeds the motion parameter threshold. Upon the Travel VR User Interface Engine determining the first motion parameter exceeds the motion parameter threshold, the Travel VR User Interface Engine then determines an adjusted motion parameter. In some embodiments, the Travel VR User Interface Engine then configures the adjusted motion parameter to be applied to the first motion parameter.

The first input may include one of a joystick input, a body-motion related input, a haptic input, a capacitive input, a game controller input, a headset input, a wearable input, a smartphone input, a computer input, a physiological input (e.g., eye tracking), a neurophysiological input (e.g., EEG), and an electronic device input. The user may use multiples devices to provide an input.

In some embodiments, the Travel VR User Interface Engine may, when determining whether first motion parameter exceeds a motion parameter threshold, determine a target location. The Travel VR User Interface Engine may select the target location based on at least one of the first input. The Travel VR User Interface Engine may then determine an adjusted motion parameter threshold, based on the target location and configure the adjusted motion parameter to be applied to the first motion parameter. For example, the user may jump/teleport to the target location. In some embodiments, the Travel VR User Interface Engine may select the target location based on at least one of a landmark or point-of-interest within a particular geography within a proximity of the user. In some embodiments, the Travel VR User Interface Engine may select the target location based on at least metadata associated with a user. In some embodiments, machine learning (e.g., convolutional neural networks) may be implemented wherein the machine learning may be trained using at least user meta data and/or the geographic data associated with user based on traversal within the VR environment. Based on the machine learning, the Travel VR User Interface Engine may be able to determine a priority level with respect to travelling to certain travel location and may automatically adjust the first motion parameter. For example, if the user is traversing a virtual model of the city of Vancouver, Canada, the Travel VR User Interface Engine implemented a neural network that is trained with the user’s metadata may suggest that the user enjoys sunsets at a waterfront point of interest. Based on the time of day, if the time is proximate to sunset and the user would have to traverse significant distance to reach the travel location, the Travel VR User Interface Engine would automatically adjust the first motion parameter in order to ensure the user arrives at the travel location to enjoy the sunset.

In some embodiments, the Travel VR User Interface Engine may receive a second input from a user input, wherein the user input triggers a Hyperjump. In this embodiment, the user input acts as a superseding manual override to specifically trigger a HyperJump to advance to the travel location. In some embodiments, the user input for triggering a HyperJump may be implemented in conjunction with any of the other embodiments for Hyperjump discussed within this disclosure.

In some embodiments, the Travel VR User Interface Engine may receive a second input from the VR interface, wherein the second input comprises a second motion parameter. The Travel VR User Interface Engine then determines whether a difference between the first motion parameter and the second parameter exceeds a motion parameter threshold. If this threshold is exceeded, the Travel VR User Interface Engine determines an adjusted motion parameter threshold and configures the adjusted motion parameter to be applied to the second motion parameter.

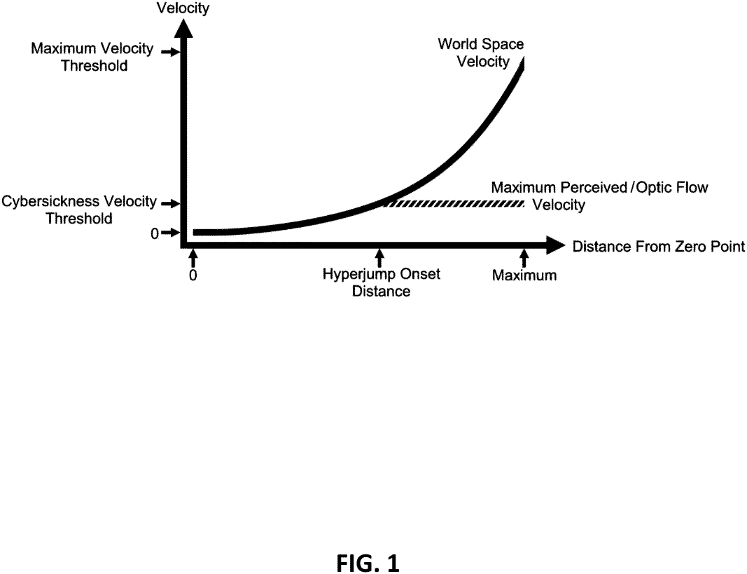

Motion parameter threshold may be referred to as a HyperJump. FIG. 1 illustrates when a HyperJump is reached, the continuous locomotion is augmented by adding iterative “HyperJumps”, such as teleport, jumping and other discontinuous travel modes, or other rapid travel modes such as dashing (high-speed continuous travel to next location instead), micro dashing (extremely short <60 ms dashes)), cross-fading between locations, cinematic transitions etc.) without having to manually switch or otherwise initiate/trigger a different travel modality.

For example, instead of increasing the continuous locomotion speed (and optic flow) beyond the HyperJump when users aim for higher speeds (e.g., by deflecting the joystick/thumbstick further, or leaning further when using a leaning-based interface), iterative HyperJumps are added, and the jump distance increases (as e.g., joystick deflection increases) such that users can directly control overall net travel speeds using the same input method (e.g., joystick deflection) without increasing optic flow further, thus limiting adverse side-effects such as motion sickness. Net travel speeds refer here to an averaged distance traveled per time unit, with the traveled distance being comprised of the sum of the distance traveled via continuous locomotion plus the distance traveled by the HyperJump(s).

Thus, the Travel VR User Interface Engine may be configured such that the player can move at the overall (average) speed they wish but never experience their environment traveling faster than the cybersickness threshold (as the optic flow is limited by the continuous locomotion velocity, which will never surpass the HyperJump).

In some embodiments, an exponential transfer function was implemented to allow both precise locomotion, especially at short distances/speeds as well as covering large distances. In some embodiments, in addition to jump distance, the Travel VR User Interface Engine was configured to utilize jump frequency as a motion parameter. This motion parameter could also be modified if desired. In some embodiments, the Travel VR User Interface Engine indicated that changing jump distance instead of jump frequency was perceived as more predictable and controllable.

In some embodiments, the Travel VR User Interface Engine can use any continuous locomotion input method to move through VR (e.g., joystick, mouse+keyboard, VR controllers, leaning-based, driving or flight simulator controls etc -HyperJump works for all of them, independent of which method is chosen).

In some embodiments, as the Travel VR User Interface Engine receives a user input that gets closer to the HyperJump, the Travel VR User Interface Engine may provide a path prediction (future trajectory) UI may appear, as well as an indication of the future jump locations.

In some embodiments, the Travel VR User Interface Engine may be configured to receive sound cues that may indicate the upcoming HyperJump (e.g., by switching from a slower and more ambient sound/music to more up-beat music).

In some embodiments, the Travel VR User Interface Engine may be configured to receive visual and non-visual cues that may indicate the upcoming HyperJump (e.g., by providing a visual cue (e.g., increasing the size, brightness, or contrast of the target location) or non-visual cue (e.g., tactile feedback from controllers or other VR equipment, vibrations of the floor/seat)).

Extensive pilot testing of the Travel VR User Interface Engine has been conducted with diverse user participants to increase maneuverability, predictability, and agency, and allows users to better understand and estimate when and where to they might be hyperjumping once they cross the HyperJump.

In some embodiments, the Travel VR User Interface Engine may adjust the first motion parameters during the VR experience. For example, the Travel VR User Interface Engine may adjust the first motion parameters based on user input. When users start getting motion sick, the Travel VR User Interface Engine could receive this input (by voice or any other input device) and reduce the HyperJump velocity/acceleration threshold such that HyperJumps happen at lower velocities/accelerations, such reducing the likelihood of motion sickness deteriorating. In another example, the Travel VR User Interface Engine is implemented on a video game console. The Travel VR User Interface Engine may receive signals for pressing the controllers A/B (Down/Up) buttons to reduce or increase (factor of 2) the threshold velocity where you transition from continuous locomotion to HyperJumping. If you are very susceptible to motion sickness or notice first signs of developing motion sickness, press the down (A) button on the controller (multiple times if desired). If you are not very susceptible to motion sickness or would like to fly at higher continuous locomotion velocity, press the up (B) button on the controller (multiple times if desired). Note that repeated A or B button press halves or doubles the threshold velocity for each button press, respectively.”

In some embodiments, the Travel VR User Interface Engine may adjust the motion parameter threshold based on Machine learning/Al algorithms based on various sensor data, such as multi-modal deep fusion approaches combining eye- and head-tracking or eye tracking, user’s body sway, detected by e.g., using a force plat or tracking data, using established methods.

In some embodiments, the Travel VR User Interface Engine may adjust the motion parameter threshold based on a user indicated preference for a specific VR session. For example, the user is tired and has another work meeting right afterwards. Thus, the Travel VR User Interface Engine may adjust a risk profile to reduce the HyperJump to levels where the user will not experience any motion sickness.

In some embodiments, the Travel VR User Interface Engine may modify inputs, motion parameters, and or other Travel VR User Interface Engine related information based on at least one of the following variants: HyperJump in combination with any display technology for mediated content (monitor & displays, projection screen, head mounted displays in open or closed form), HyperJump in combination with computer generated content (e.g., VR), HyperJump in combination with photographic material (e.g., 360 degree cameras, drones), HyperJump in combination with embodied directional velocity control (leaning-based control) while in sitting or standing position, HyperJump in combination with various handheld controls while in sitting or standing position, HyperJump in combination with passive control conditions in which travel speed and direction is not directly controlled by the user (e.g., in tethered multiplayer mode), HyperJump in combination with various forms of visual effects supporting spatial continuity, HyperJump in combination with path prediction and jump size indication, HyperJump in combination with multi-person experiences, HyperJump in combination with seamless blended cruise control, HyperJump in combination with auditory cues for time synchronicity (e.g., up-beat music), HyperJump in combination with body sensors for vegetative functions (e.g., EEG, heat beat, breathing, skin conductance), HyperJump in combination with tracking of body parts (e.g., head, limbs, eyes, torso), HyperJump in combination with reduced perceived velocity by various means (e.g., limited field of view, countervection, reduced contrast/visibility, blurring (incl. overall or peripheral)), HyperJump applied to motion control in 3D (not just ground-based 2D or 1D) virtual travel, including flying, diving, space travel etc, teleporting/discontinuous locomotion techniques use with HyperJump can be augmented by a variety of methods and potential blending techniques, such as crossfades (implemented), dash/micro-dash (implemented), cinematic transitions etc.)

In some embodiments, the Travel VR User Interface Engine can transition (e.g., using the adjusted motion parameter to alter VR user’s input to alter a first motion parameter) which can be initiated by a number of different methods, such as at fixed or flexible time intervals (e.g., every second, on the beat of music, depending on environmental saliency or objects/regions of interest, or other characteristics of the environment or user data (behavioral, neurophysiological, physiological, neurochemical etc). In such transitions, the Travel VR User Interface Engine may be initiated automatically for example when users would be likely to experience adverse or undesirable/adverse user experiences such as disorientation, discomfort, unease, or motion sickness (aka Cybersickness, VR sickness). For example, transitions could be triggered when movement parameters (including, but not limited to speed, accelerations, jerks (acceleration changes), pitch, yaw, or roll orientation reach levels likely to induce motion sickness or other undesirable user experiences (e.g., fast movements, high accelerations/breaking, jerks etc.) For example, transitions/switching could be triggered based on motion parameters, such as when user’s self-motion (or object motion) reaches a threshold (e.g., based on velocity, acceleration, and/or jerks (changes in acceleration changes)). It should be noted that each threshold can be based on the overall value (magnitude), or one or a combination of several measures/parameters or several degrees of freedom (e.g., forward/backward, sideways, up/down, roll, pitch, yaw). In some embodiments, these thresholds and other parameters can be selected based on pilot testing and/or user preferences (both before and during usage). For example, when users start getting motion sick, they could (by voice or any other input method) reduce the HyperJump velocity threshold such that HyperJumps happen at lower velocities, thus reducing the likelihood of motion sickness deteriorating. Before the VR experience users could indicate their motion sickness susceptibility (e.g., using one of the established questionnaires) or their preference for the current session (e.g., I’m tired today and have another work meeting right afterwards, so I really cannot afford to get sick, so let’s reduce the HyperJump thresholds to levels where I’m sure I won’t experience any motion sickness.

In some embodiments, the Travel VR User Interface Engine may also configure these parameters based on a combination of methods including the Travel VR User Interface Engine detecting whether users directly or indirectly indicate the desire to shift locomotion mode, or express/experience unease (e.g., onset of motion sickness, disorientation, discomfort, ...). This could be done, e.g., by verbal commands such as defined keywords/utterances; behavioral indicators, such as interacting using some kind of human-computer interfaces (e.g., controller, keyboard, mouse, joystick), gestural interfaces, body tracking, interacting using other physiological signals that users can voluntarily control, such as eye movements (e.g., looking at a specific location or producing specific eye movement patterns, blinking or blink sequences (e.g., single, double blinks); user data indicating that a transition might be advantageous, e.g., when behavioural data (body sway, centre of mass changes, postural changes, gestures, mimicry, verbal or non-verbal communication) indicate relevant aspects such as distress, unease, motion sickness, or disorientation; based on behavioural, neurophyiological, physiological, neurochemical markers either by threshold on individual markers/measures or combinations thereof. Such markers can include heart rate, pulse, & heart rate variability, EGK, Neuroimaging methods such as NIRS, EEG, MRI, fMRI, MEG, and different frequency bands thereof, eye tracking incl. EOG, including blinking, fixation on specific aspects of the environment, eye movement patterns, pupil diameter/dilation or timecourse (which can help determine motion sickness levels).

In some embodiments, the Travel VR User Interface Engine may tackle the limitations of the prior art in the field by automatically adding intermittent jumps once the user reaches a threshold motion parameter (e.g., velocity, acceleration...) where users are more likely to experience adverse effects such as cybersickness. The Travel VR User Interface Engine may alter distance travelled with teleportation/HyperJumping and can be changed to any degree as it does not create optical flow during the teleportation/HyperJumping and thus avoids cybersickness.

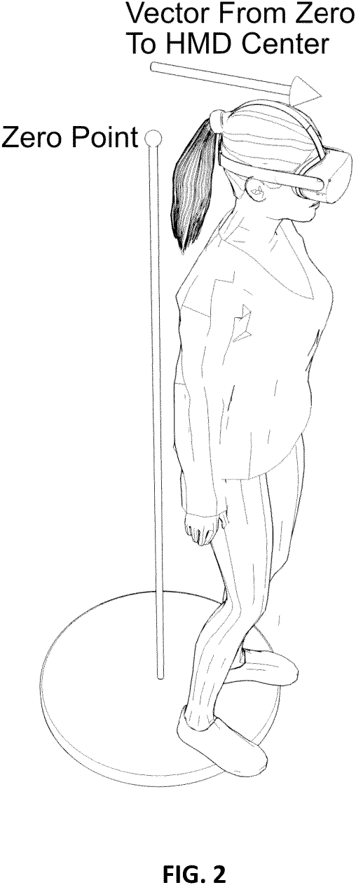

In some embodiments, the Travel VR User Interface Engine may implement a spatial updating interface supported by leaning-based interface vs. a controller for non-trivial locomotion in a highly realistic city environment. In addition, we investigated the effect of adding short iterative jump to both interfaces (“HyperJump”). For example, FIG. 2 illustrates a standing user using a leaning-based VR locomotion interface (Similar to NaviBoard where a VR headset provides an input of distance and direction from the zero point which can be used to control translational speed in VR, similar to deflecting a joystick.

In some embodiments, the Travel VR User Interface Engine is configured with a choice of leaning-based and controller-based Travel VR User Interface Engine, which is still the most common interfaces for locomotion in large-scale virtual environments. In some embodiments, the Travel VR User Interface Engine may implement user-interfaces that may be used while seated or standing, with or without physical rotation. Below we explain details about a specific embodiment where users are seated and physically rotating.

In some embodiments, the Travel VR User Interface Engine receives inputs from participants where the participants leaned their upper body (e.g., HeadJoystick) as if it was a joystick to translate in the desired (i.e., leaning) direction up to a virtual speed of 10 m/s mimicking inner city driving speeds. In some embodiments, the Travel VR User Interface Engine is configured to implement a controller (e.g., Participants use the default Oculus controller thumb-stick) to translate in the desired direction up to a virtual speed of 10 m/s. The Travel VR User Interface Engine may implement the controller-directed steering where the controller’s forward direction determines the forward direction of the movement, i.e., the user can rotate the controller, physically rotate, or press the thumbstick sideways to change the moving direction.

In some embodiments, the Travel VR User Interface Engine works like a HeadJoystick up to the virtual continuous translation speed threshold of 5 m/s. Leaning further adds a jump of 1-8 meter every 0.5 second, on top of their continuous translation of 5 m/s. Leaning further increases jump distance, but not frequency. The same could be done with a controller (similar to HeadJoystick-Teleport but with a controller).

In some embodiments, the Travel VR User Interface Engine works like a HeadJoystick up to the virtual continuous translation speed threshold of 5 m/s. Leaning further adds a jump of 1-8 meter.

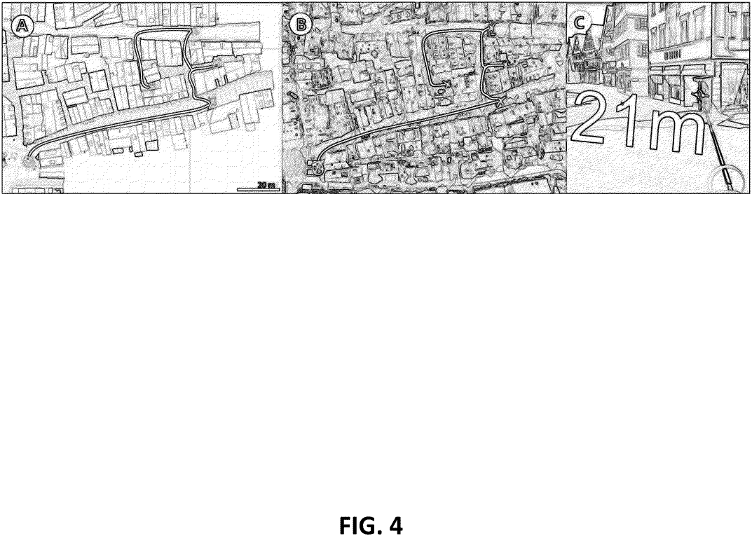

In some embodiments, a simulation was run where the Travel VR User Interface Engine ran a test in a virtual model of part of downtown Tübingen, Germany, which provided a naturalistic complex environment. Four different non-intersecting paths were created so that participants travelled a unique path with each interface. FIG. 4 illustrates various paths a participant has taken in a VR environment. As seen from the path in FIG. 4, the participant started from the red circle. They performed trivial pointing (FIG. C) to two targets from that spot to familiarize themselves with the task and make sure that they learn the targets. After completing the pointing task, they would follow 10 waypoints to the next target. The program would then prompt them to point and estimate the previously visited targets’ distance in random order. In total, they perform non-trivial pointing from four locations along each path. The experiment used a within-subject design where every participant took part in all four conditions with a different path for each interface. A latin-square design with blocking of partial-body-based interface (HeadJoystick, HeadJoystick-Teleport) and controller-based interface (Controller, Controller-Teleport) was used to account for ordering effect and varying path difficulties. (A) One of the virtual paths in the experiment. (B) The top-down view of part of Tübingen on which path (A) is based. Participants start from the red circle, move to the subsequent red crosses and point back to the previously visited places in random order as prompted by the program. (C) Trivial pointing task (not included in the analysis) where participants point and indicate the distance to the target.

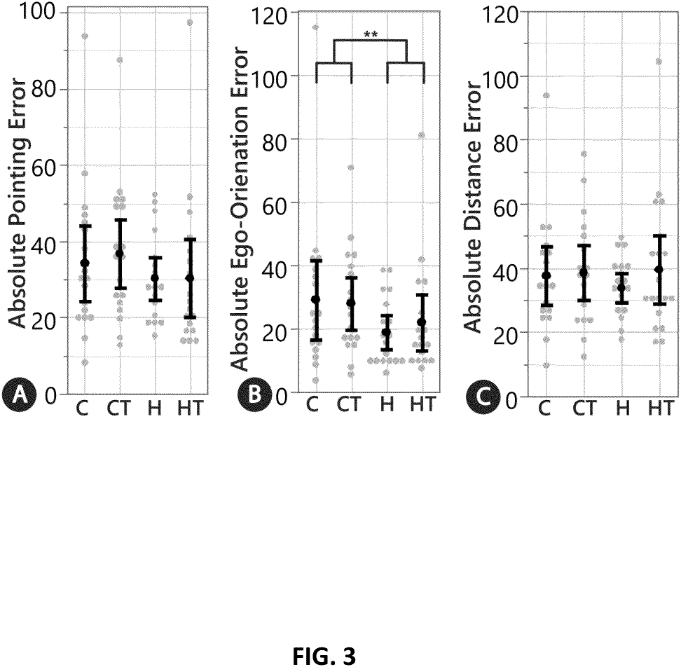

In this example, the Travel VR User Interface Engine created results from the test. The obtained data were analyzed using 2×2 repeated-measures ANOVAs with the independent variables interface embodiment (leaning-based vs. controller-based) and teleportation (no jump vs. jump). Since there was no significant interaction in any case, only main effects are reported. In one implementation, an Absolute Pointing Error was utilized. This Absolute Pointing Error is used to assess how accurately participants knew where they were within the environment. It was measured by averaging (14 per interface) the absolute difference between the pointing direction (pointer’s yaw) and the actual direction. ANOVA revealed a trend for the average absolute pointing error to be reduced for leaning-based (M = 30.3°,SD = 16.3°) compared to controller-based interfaces (M = 35.5°,SD = 18.8°) which reached marginal significance, F(1,17) = 3.64, p = 0.074, η2p=0.176. I.e. controller-based interfaces causes a 17% increase in pointing error. There was no significant effect of teleportation, F(1,17) = 0.186, p = 0.672, η2p=0.011, see FIG. 3, chart A.

In one implementation, Absolute Ego-Orientation Error was used. Absolute Ego-Orientation Error is the one of the major reasons for absolute pointing error can be participants’ misperception of their current ego-orientation. Average of the signed pointing error from each pointing location was used to calculate the absolute ego-orientation error. Then, it was averaged (4 per interface) for each interface. ANOVA revealed that using leaning-based interface (M = 20.5°,SD = 14.5°) significantly improved ego-orientation over controller-based (M = 28.6°,SD = 20.9°), F(1,17) = 9.57, p = 0.007, η2p=0.360, i.e. a 39.5% improvement. There was no significant effect of teleportation, F(1,17) = 0.160, p = 0.694, η2p=0.009, see FIG. 4. FIG. 3 illustrates various types of errors associated with the participant in the VR environment. In FIG. 3. the black dots and bars represent means and 95% CI for (A) Absolute Pointing Error (B) Absolute Ego Orientation Error (C) Absolute Distance Error. The gray dots represent the error averaged for an interface for each participant. C = Controller, CT = Controller-Teleport, H = HeadJoystick, HT = HeadJoystick-Teleport

In one implementation, Absolute Distance Error was used. Absolute Distance Error is measured by averaging the absolute difference between the participant’s estimated distance and actual distance from the pointing location. ANOVA revealed no significant effect of embodiment, F(1,17) = 0.207, p = 0.655, η2p=0.012 or teleportation, F(1,17) = 1.96, p = 0.180, η2p=0.103, see FIG. 4.

In one implementation, the Travel VR User Interface Engine used a photo realistic environment coupled with a naturalistic spatial updating task to better assess the spatial updating capabilities of the interface and make stronger claims. Though previous works have shown improved spatial orientation using leaning-based interfaces compared to controller, the test is the first to show a significant difference between the interfaces with a spatial updating pointing task in a realistic environment.

There have been no studies that evaluated spatial updating performance when adding teleportation to continuous methods of travel. These findings indicate that HyperJumps did not negatively affect spatial updating capabilities compared to their respective continuous interfaces. It is not possible to prove through null hypothesis testing that the jumps do not have any effect on spatial orientation, but the p-value and effect size suggest a negligible difference when Hyper-Jump is introduced to the interface. These results find minimal difference between continuous vs discrete movement and extend it to a more ecologically valid task and environment. These data illustrate that discrete movements help combat cybersickness and do not compromise the spatial updating.

In one implementation, users could use a leaning-based 3D (flying) locomotion interface to fly through a large photorealistic 3D model (a “virtual twin” = highly accurate model of Downtown Vancouver, BC, Canada). User testing with more than a dozen participants of diverse ages, backgrounds, and VR experiences showed that switching on HyperJumping (as compared to just continuous locomotion) drastically reduced motion sickness for all users, even those who are highly susceptible to motion sickness. That is, we observed extremely low nausea levels even when flying through a highly naturalistic large 3D model at often quite fast speeds.

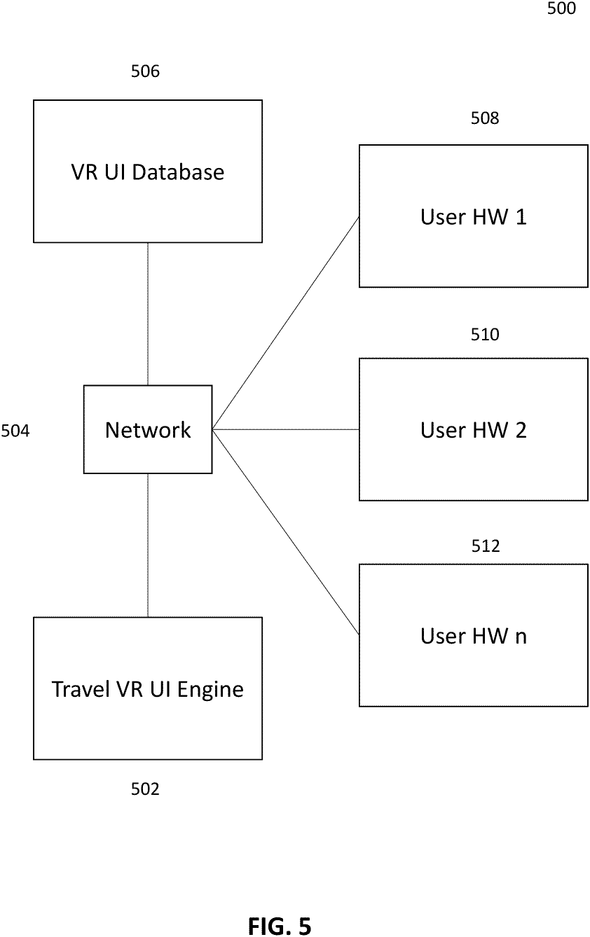

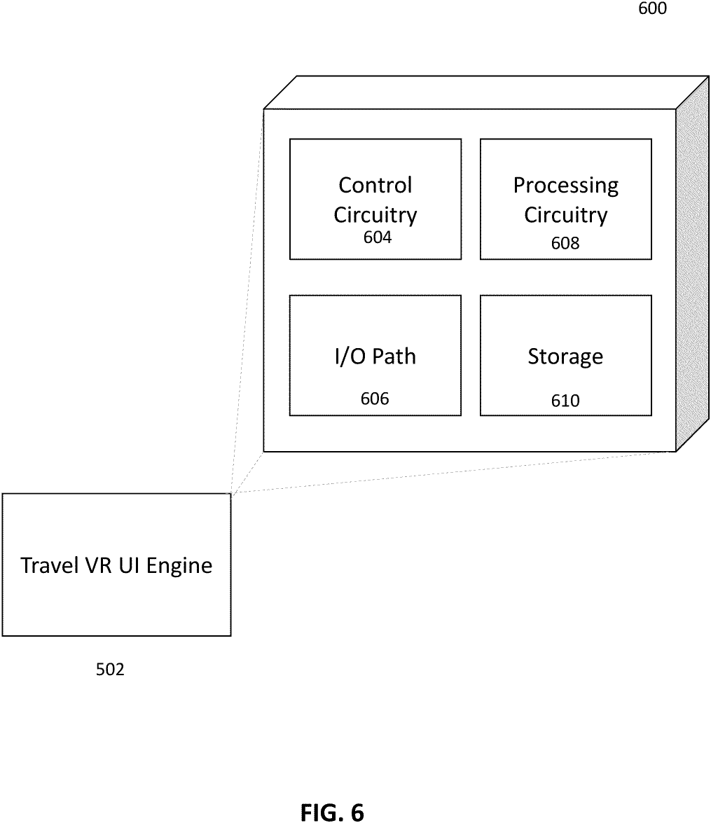

FIG. 5 shows a system diagram of a travel VR UI engine, VR UI database, a network, and user hardware, in accordance with some embodiments of the disclosure. The system 500 includes a Travel VR UI Engine 502 which may be of any hardware that provides for processing VR based processes. The Travel VR UI Engine 502 may be communicatively coupled, via a network 504 to multiple user hardware devices in a defined environment (e.g., user hardware 1 (508), user hardware 2 (510), and user hardware ‘n’ (512)). The Travel VR UI Engine 502 may be coupled to a VR UI Database 506. A further detailed disclosure on the Travel VR UI Engine 502 can be seen in FIG. 6 showing an illustrative block diagram of the Travel VR UI Engine 502, in accordance with some embodiments of the disclosure.

In some embodiments, the Travel VR UI Engine 502 may be implemented remote from the user hardware (508, 510, 512) such as a cloud server configuration. In yet other embodiments, the Travel VR UI Engine 502 may be integrated into the user hardware or be physically coupled to the user hardware. For example, the processing may occur with a VR headset. Any of the system modules (e.g., Travel VR UI Engine, VR UI Database, user hardware) may be any combination of shared or disparate hardware pieces that are communicatively coupled.

In some embodiments, the Travel VR UI Engine 502 may be any computing hardware capable of providing VR processing. For example, the Travel VR UI Engine may be a could based server, a local server, a processor embedded into an electronic device (e.g., gaming console, personal computer, smartphone, tablet, and/or any other electronic device).

In some embodiments, the user hardware (508, 510, 512) may be any hardware that provides VR related signals (e.g., for navigation, for selection options, etc.). For example, the user hardware may include, but is not limited to, electronic devices that provide joystick input, a body-motion related input, a haptic input, a capacitive input, a game controller input, a headset input, a wearable input, a smartphone input, a computer input, a physiological input (e.g., eye tracking), a neurophysiological input (e.g., EEG), and an electronic device input. The user may use multiples devices to provide an input (e.g., game controller, wearable device or headset, keyboard, mouse, other user input). For example, the user hardware a network-connected devices (e.g., Internet-of-Things devices), smartphones, personal computers, smart appliances, consumer electronics, industrial equipment, security systems, digital twin systems, and similar system.

In some embodiments, the VR UI database is a data structure that stores any information related to the system. This information may include operational information, user based information (e.g., user specific motion parameter thresholds), VR information (e.g., path, environmental information). The VR UI database may be any type of hardware which has storage capacity with an interface to couple to the Travel VR UI Engine. For example, the VR UI database may be a cloud based storage hardware, or it may be integrated into user hardware, and/or it may be integrated into the Travel VR UI Engine.

FIG. 6 shows an illustrative block diagram 600 of the Travel VR UI Engine 502, in accordance with some embodiments of the disclosure. In some embodiments, the Travel VR UI Engine may be communicatively connected to a user interface. In some embodiments, the Travel VR UI Engine may include processing circuitry, control circuitry, and storage (e.g., RAM, ROM, hard disk, removable disk, etc.). The Travel VR UI Engine may include an input/output path 606. I/O path 606 may provide device information, or other data over a local area network (LAN) or wide area network (WAN), and/or other content and data to control circuitry 604, which includes processing circuitry 608 and storage 610. Control circuitry 604 may be used to send and receive commands, requests, and other suitable data using I/O path 606. I/O path 606 may connect control circuitry 604 (and specifically processing circuitry 608) to one or more communications paths.

Control circuitry 604 may be based on any suitable processing circuitry such as processing circuitry 608. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 404 executes instructions for a Travel VR UI Engine stored in memory (e.g., storage 610).

Memory may be an electronic storage device provided as storage 610 which is part of control circuitry 604. As referred to herein, the phrase “electronic storage device” or “storage device” should be understood to mean any device for storing electronic data, computer software, or firmware, such as random-access memory, read-only memory, hard drives, solid state devices, quantum storage devices, or any other suitable fixed or removable storage devices, and/or any combination of the same. Nonvolatile memory may also be used (e.g., to launch a boot-up routine and other instructions).

The Travel VR UI Engine 502 may be coupled to a communications network. Communications network may be one or more networks including the Internet, a mobile phone network, mobile voice or data network (e.g., a 5G, 4G or LTE network), mesh network, peer-2-peer network, cable network, or other types of communications network or combinations of communications networks. Paths may separately or together include one or more communications paths, such as, a satellite path, a fiber-optic path, a cable path, a path that supports Internet communications, free-space connections (e.g., for broadcast or other wireless signals), or any other suitable wired or wireless communications path or combination of such paths.

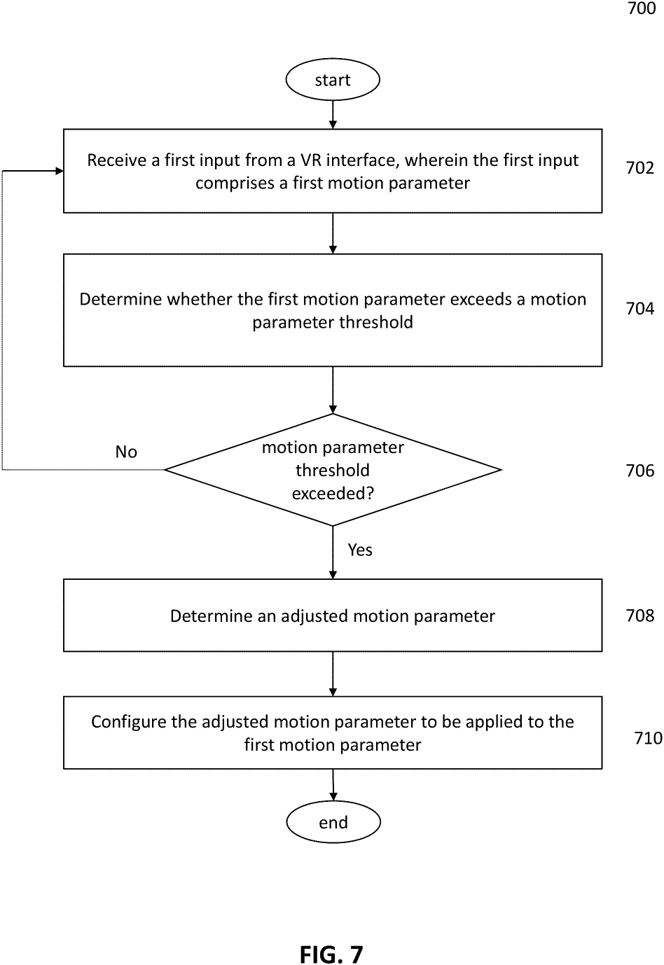

FIG. 7 is an illustrative flowchart of a process for configuring the adjusted motion parameter to be applied to the first motion parameter, in accordance with some embodiments of the disclosure. Process 700, and any of the following processes, may be executed by control circuitry 604 (e.g., in a manner instructed to control circuitry 604 by the Travel VR UI Engine). Control circuitry 604 may be part of the Travel VR UI Engine 502, or of a remote server separated from the control system by way of a network, or distributed over a combination of both.

At 702, the Travel VR UI Engine, by control circuitry 604, receives a first input from a VR interface, wherein the first input comprises a first motion parameter. The Travel VR UI Engine may receive the first input through the I/O path 606 which may be coupled to an user hardware device 508-512.

At 704, the Travel VR UI Engine, by control circuitry 604, determines whether the first motion parameter exceeds a motion parameter threshold. The Travel VR UI Engine may determine whether the motion parameter threshold is exceeded using the processing circuitry 608.

If, at 706, control circuitry 604 determines “Yes,” the motion parameter threshold is exceeded, the process advances to 708. At 708, the Travel VR UI Engine, by control circuitry 604, determines an adjusted motion parameter. Travel VR UI Engine 502 may determine the adjusted motion parameter by receiving data from the at least one of the user hardware 508-512 and the VR UI database 506 and storage 610. Travel VR UI Engine 502 may determine of the adjusted motion parameter may be determined by processing circuitry 608. If, at 706, control circuitry determines “No,” the process reverts to 702.

At 710, the Travel VR UI Engine, by control circuitry 604, configures the adjusted motion parameter to be applied to the first motion parameter.

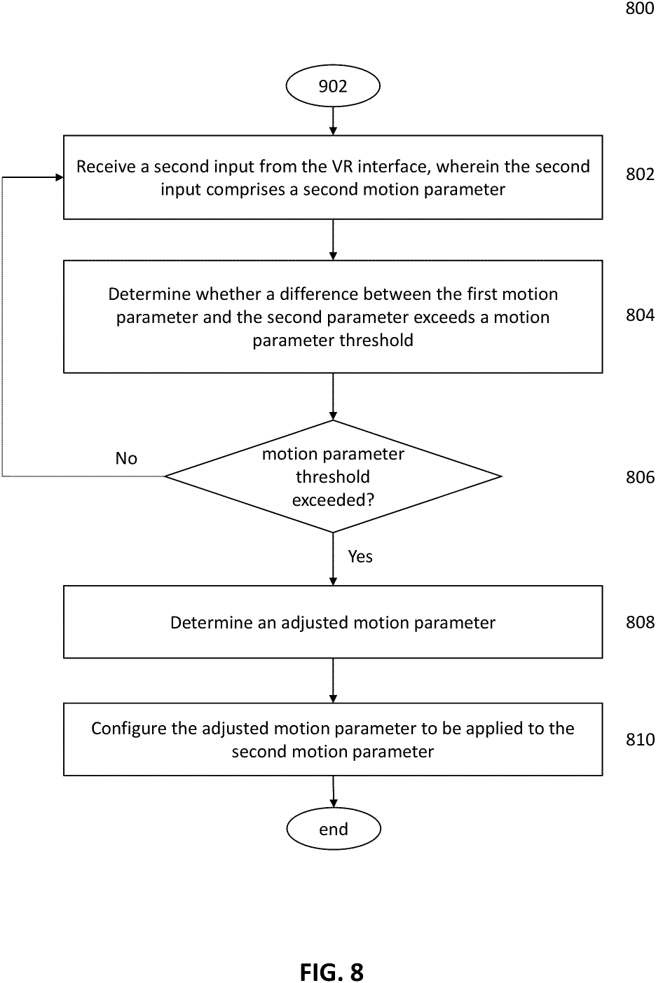

FIG. 8 is an illustrative flowchart of a process for configuring the adjusted motion parameter to be applied to the second motion parameter, in accordance with some embodiments of the disclosure. At 802, the Travel VR UI Engine, by control circuitry 604, receives a second input from the VR interface, wherein the second input comprises a second motion parameter. The Travel VR UI Engine may receive the second input through the I/O path 606 which may be coupled to an user hardware device 508-512.

At 804, the Travel VR UI Engine, by control circuitry 604, determines whether a difference between the first motion parameter and the second parameter exceeds a motion parameter threshold. The Travel VR UI Engine may determine whether the motion parameter threshold is exceeded using the processing circuitry 608.

If, at 806, control circuitry 604 determines “Yes,” the motion parameter threshold is exceeded, the process advances to 808. At 808, the Travel VR UI Engine, by control circuitry 604, determines an adjusted motion parameter. Travel VR UI Engine 502 may determine the adjusted motion parameter by receiving data from the at least one of the user hardware 508-512 and the VR UI database 506 and storage 610. Travel VR UI Engine 502 may determine of the adjusted motion parameter may be determined by processing circuitry 608. If, at 806, control circuitry determines “No,” the process reverts to 802.

At 710, the Travel VR UI Engine, by control circuitry 604, configures the adjusted motion parameter to be applied to the second motion parameter.

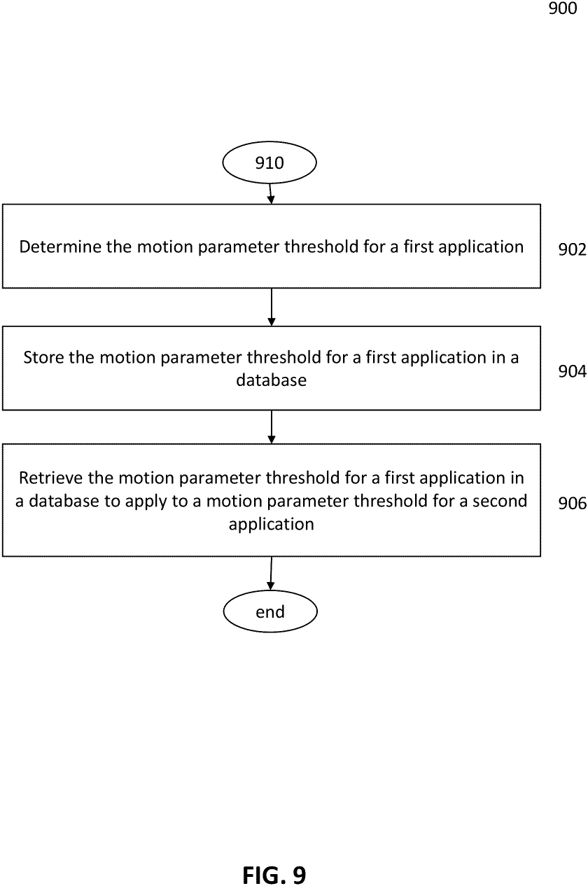

FIG. 9 is an illustrative flowchart of a process for retrieving the motion parameter threshold for a first application in a database to apply to a motion parameter threshold for a second application, in accordance with some embodiments of the disclosure. At 902, the Travel VR UI Engine, by control circuitry 604, determine the motion parameter threshold for a first application. The Travel VR UI Engine may determine this motion parameter threshold by receiving data from the at least one of the user hardware 508-512 and the VR UI database 506 and storage 610.

At 904, the Travel VR UI Engine, by control circuitry 604, stores the motion parameter threshold for a first application in a database. The database may be at least one of the user hardware 508-512 and the VR UI database 506 and storage 610.

At 906, the Travel VR UI Engine, by control circuitry 604, retrieves the motion parameter threshold for a first application in a database to apply to a motion parameter threshold for a second application.

It is contemplated that the steps or descriptions of FIGS. 7-9 may be used with any other embodiment of this disclosure. In addition, the steps and descriptions described in relation to FIGS. 7-9 may be done in alternative orders or in parallel to further the purposes of this disclosure. For example, each of these steps may be performed in any order or in parallel or substantially simultaneously to reduce lag or increase the speed of the system or method. Any of these steps may also be skipped or omitted from the process. Furthermore, it should be noted that any of the devices or equipment discussed in relation to FIGS. 5-6 could be used to perform one or more of the steps in FIGS. 7-9.

The processes discussed above are intended to be illustrative and not limiting. One skilled in the art would appreciate that the steps of the processes discussed herein may be omitted, modified, combined, and/or rearranged, and any additional steps may be performed without departing from the scope of the invention. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

### Interpretation of Terms

Unless the context clearly requires otherwise, throughout the description and any accompanying claims (where present), the words “comprise,” “comprising,” and the like are to be construed in an inclusive sense, that is, in the sense of “including, but not limited to.” As used herein, the terms “connected,” “coupled,” or any variant thereof, means any connection or coupling, either direct or indirect, between two or more elements; the coupling or connection between the elements can be physical, logical, or a combination thereof. Additionally, the words “herein,” “above,” “below,” and words of similar import, shall refer to this document as a whole and not to any particular portions. Where the context permits, words using the singular or plural number may also include the plural or singular number respectively. The word “or,” in reference to a list of two or more items, covers all of the following interpretations of the word: any of the items in the list, all of the items in the list, and any combination of the items in the list.

Various features are described herein as being present in “some embodiments”. Such features are not mandatory and may not be present in all embodiments. Embodiments of the invention may include zero, any one or any combination of two or more of such features. This is limited only to the extent that certain ones of such features are incompatible with other ones of such features in the sense that it would be impossible for a person of ordinary skill in the art to construct a practical embodiment that combines such incompatible features. Consequently, the description that “some embodiments” possess feature A and “some embodiments” possess feature B should be interpreted as an express indication that the inventors also contemplate embodiments which combine features A and B (unless the description states otherwise or features A and B are fundamentally incompatible).

Specific examples of systems, methods and apparatus have been described herein for purposes of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting combining features, elements and/or acts from described embodiments.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

We claim:

1. A method for adjusting motion parameter thresholds for VR locomotion comprising:
receiving a first input from a VR interface, wherein the first input comprises a first motion parameter;
determining whether the first motion parameter exceeds a motion parameter threshold; and
in response to the determination that the first motion parameter exceeds the motion parameter threshold:
determining an adjusted motion parameter; and
configuring the adjusted motion parameter to be applied to the first motion parameter.

2. The method of claim 1, further comprising:
receiving a second input from the VR interface, wherein the second input comprises a second motion parameter;
determining whether a difference between the first motion parameter and the second parameter exceeds a motion parameter threshold:
in response to the determination that the difference between the first motion parameter and the second parameter exceeds the motion parameter threshold,
determining an adjusted motion parameter; and
configuring the adjusted motion parameter to be applied to the second motion parameter.

3. The method of claim 1, wherein determining whether first motion parameter exceeds a motion parameter threshold further comprises:
determining a target location;
determining an adjusted motion parameter threshold, based on the target location; and
configuring the adjusted motion parameter to be applied to the first motion parameter.

4. The method of claim 1, wherein the first motion parameter comprises one of velocity, acceleration, changes in acceleration, distance, and coordinates.

5. The method of claim 1, wherein the first input includes one of a joystick input, a body-motion related input, a haptic input, a capacitive input, a game controller input, a headset input, a wearable input, a smartphone input, a computer input, and an electronic device input.

6. The method of claim 3, wherein the target location may be selected based on the first input.

7. The method of claim 1, wherein the motion parameter threshold is configured by an administrator.

8. The method of claim 1, wherein the motion parameter threshold is determined by a motion parameter threshold calibration.

9. The method of claim 8, wherein the parameter threshold calibration is determined based on the first input.

10. The method of claim 1, further comprising:
determining the motion parameter threshold for a first application; and
storing the motion parameter threshold for a first application in a database; and
retrieving the motion parameter threshold for a first application in a database to apply to a motion parameter threshold for a second application.

11. A system for adjusting motion parameter thresholds for VR locomotion comprising:
control circuitry configured to:
receive a first input from a VR interface, wherein the first input comprises a first motion parameter;
determine whether the first motion parameter exceeds a motion parameter threshold; and
in response to the determination that the first motion parameter exceeds the motion parameter threshold:
determine an adjusted motion parameter; and
configure the adjusted motion parameter to be applied to the first motion parameter.

12. The system of claim 11, wherein the control circuitry is further configured to:
receive a second input from the VR interface, wherein the second input comprises a second motion parameter;
determine whether a difference between the first motion parameter and the second parameter exceeds a motion parameter threshold:
in response to the determination that the difference between the first motion parameter and the second parameter exceeds the motion parameter threshold,
determine an adjusted motion parameter; and
configure the adjusted motion parameter to be applied to the second motion parameter.

13. The system of claim 11, wherein the control circuitry when determining whether first motion parameter exceeds a motion parameter threshold is further configured to:
determine a target location;
determine an adjusted motion parameter threshold, based on the target location; and
configure the adjusted motion parameter to be applied to the first motion parameter.

14. The system of claim 11, wherein the first motion parameter comprises one of velocity, acceleration, changes in acceleration, distance, and coordinates.

15. The system of claim 11, wherein the first input comprises one of a joystick input, a body-motion related input, a haptic input, a capacitive input, a game controller input, a headset input, a wearable input, a smartphone input, a computer input, and an electronic device input.

16. The system of claim 13, wherein the target location may be selected based on the first input.

17. The system of claim 11, wherein the motion parameter threshold is configured by an administrator.

18. The system of claim 11, wherein the control circuitry is configured to determine the motion parameter threshold by a motion parameter threshold calibration.

19. The system of claim 18, wherein the parameter threshold calibration is determined based on the first input.

20. The system of claim 11, wherein the control circuitry is further configured to:
determine the motion parameter threshold for a first application; and
store the motion parameter threshold for a first application in a database; and
retrieve the motion parameter threshold for a first application in a database to apply to a motion parameter threshold for a second application.
